(19) United States
(12) Patent Application Publication
(10) Pub. No.: US 2015/0096235 A1
(43) Pub. Date: Apr. 9, 2015

(54) DOOR SILL ASSEMBLY, DOOR SILL AND KIT THEREFOR

(71) Applicant: Oded Eddy Rochman, Thornhill (CA)

(72) Inventor: Oded Eddy Rochman, Thornhill (CA)

(21) Appl. No.: 14/049,602

(22) Filed: Oct. 9, 2013

(51) Int. Cl. E06B 1/70; E06B 7/18; E06B 7/14

(52) U.S. Cl. CPC E06B 1/70; E06B 7/14; E06B 7/18; E06B 2001/707
USPC 49/470; 49/471

(57) ABSTRACT

A door sill assembly comprises a door sill comprising a sill crown having one or more upper drain apertures therein, a sill tread defining a stepping surface, and an internal support at least partially supporting the sill crown and the sill tread and having a drainage surface. At least a portion of the drainage surface is sloped, and at least one of the sill tread and the internal support has one or more lower drain apertures therein. The drainage surface defines at least one internal drainage channel in fluid communication with at least one upper drain aperture and at least one lower drain aperture. At least one of the sill crown, the sill tread, and the internal support is separately formed.

### FIELD OF THE INVENTION

The present invention relates generally door frames and in particular, to a door sill assembly, door sill and kit therefor.

### BACKGROUND OF THE INVENTION

In the field of door framing, improved door frame designs are continually being developed to provide better resistance to weather elements, such as wind and rain. At the same time, new regulatory standards that require door frames to have increased resistance to water penetration are continually being introduced. As water penetration is typically greatest at the bottom of the door frame, improvements to the design of the door sill assembly are often critical to increasing the overall weather resistance of the door frame.

Door sill assemblies have been previously described. For example, Canadian Patent No. 2,775,167 to Gilbert et al. discloses a door sill assembly that comprises a sill threshold defining an upper step portion and a lower step portion. A sweep is connected to a bottom of a door slab of a door, the sweep comprising deflectors projecting downwardly from the door slab. An outermost deflector is vertically aligned with and spaced apart from the lower step portion when the door is closed to form a pressure-equalized zone open to the exterior. A second deflector is vertically aligned and in contact with the upper step portion when the door is closed. A seal is positioned interiorly relative to the deflectors and is vertically aligned with the upper step portion to form a sealed zone with the second one of the deflectors and the upper portion when the door is closed.

U.S. Pat. No. 8,448,384 to Wernlund et al. discloses a doorway with a sill attachment that increases a sill DP rating that includes spaced vertical jambs, a head jamb, and a sill that together form a door frame. The sill is a substantially hollow contain-and-drain type sill, with nosing provided with drainage openings. A hollow sill attachment is mounted to and extends along the nosing, and projects downwardly to a position below the drainage openings in the nosing of the sill. The drainage openings communicate with the interior. Weep holes that communicate with the environment are located in the sill attachment at a position below the drainage openings in the nosing of the sill. The attachment increases the column height of water that can be accommodated by the sill before leakage occurs, and thus enhances the DP rating of the sill.

Improvements are generally desired. It is therefore an object to provide a novel door sill assembly, door sill and kit therefor.

### SUMMARY OF THE INVENTION

In one aspect, there is provided a door sill assembly, comprising: a door sill comprising: a sill crown having one or more upper drain apertures therein, a sill tread defining a stepping surface, and an internal support at least partially supporting the sill crown and the sill tread and having a drainage surface, at least a portion of the drainage surface being sloped, at least one of the sill tread and the internal support having one or more lower drain apertures therein, the drainage surface defining at least one internal drainage channel in fluid communication with at least one upper drain aperture and at least one lower drain aperture, at least one of the sill crown, the sill tread, and the internal support being separately formed.

The door sill may further comprise an upwardly extending longitudinal rib, the upper drain apertures being interiorly adjacent the longitudinal rib. The door sill may further comprise a longitudinal seal disposed along the longitudinal rib. The door sill assembly may further comprise a door sweep configured to be fitted to the bottom of a door. The door sill assembly of claim 4, wherein the door sweep may comprise a downwardly depending longitudinal tab configured to cooperate with the longitudinal seal for providing a fluid barrier. The door sweep may further comprise an inclined longitudinal deflector sized to extend beyond the upwardly extending rib when the door is in a closed position. The door sweep may further comprise one or more downwardly depending flaps for engaging the sill crown.

The sill crown and the sill tread may be separately formed and connected to each other.

The door sill may further comprise a plurality of setting blocks disposed on the drainage surface for supporting at least the sill tread.

The door sill may further comprise a transverse seal at each longitudinal end of the drainage surface for providing a fluid barrier. Each transverse seal may be a length of glazing tape.

The sill tread may be formed of extruded aluminum alloy.

The sill crown may be formed of extruded polymer. The sill crown may be formed by coextrusion of a first polymer and a second polymer, the second polymer having a lower hardness than the first polymer, the longitudinal seal being formed of the second polymer.

The internal support may have a webbed configuration. The internal support may be formed of extruded polymer.

The door sweep may be formed of extruded polymer. The door sweep may be formed by coextrusion of a first polymer and a second polymer, the second polymer having a lower hardness than the first polymer, the one or more downwardly depending flaps being formed of the second polymer.

The door sill may further comprise a sill base at least partially supporting the internal support. The sill base may be separately formed. The sill base may comprise a machined board. The sill base may be formed of wood, a wood/plastic composite, or a plastic composite.

In another aspect, there is provided a door sill comprising: a sill crown having one or more upper drain apertures therein; a sill tread defining a stepping surface; and an internal support at least partially supporting the sill crown and the sill tread and having a drainage surface, at least a portion of the drainage surface being sloped, at least one of the sill tread and the internal support having one or more lower drain apertures therein, the drainage surface defining at least one internal drainage channel in fluid communication with at least one upper drain aperture and at least one lower drain aperture, at least one of the sill tread, the sill crown and the internal support being separately formed.

In another aspect, there is provided a kit for assembling a door sill, the kit comprising: a sill tread defining a stepping surface; a sill crown having one or more upper drain apertures therein; and an internal support configured to at least partially support the sill tread and the sill crown and having a drainage surface, at least a portion of the drainage surface being sloped, at least one of the sill tread and the internal support having one or more lower drain apertures therein, the drainage surface being configured to define at least one drainage channel in fluid communication with at least one upper drain aperture and at least one lower drain aperture in the assembled door sill, at least one of the sill tread, the sill crown and the internal support being separately formed.

In another aspect, there is provided a door sill assembly, comprising: a door sill comprising: an upwardly extending longitudinal rib, and a longitudinal seal disposed along an interior-facing surface of the longitudinal rib; and a door sweep configured to be fitted to a bottom of an interior-swinging door, the door sweep comprising a downwardly depending longitudinal tab configured to abut the longitudinal seal for providing a fluid barrier.

The door sweep may further comprise one or more downwardly depending flaps for engaging the door sill.

The door sweep may further comprise an inclined longitudinal deflector sized to extend beyond the upwardly extending rib when the door is in a closed position.

The door sill may further comprise: a sill tread defining a stepping surface, and a sill crown. The sill crown may comprise the longitudinal rib and the longitudinal seal. The sill crown may be formed by coextrusion of a first polymer and a second polymer, the second polymer having a lower hardness than the first polymer, the longitudinal seal being formed of the second polymer. The sill tread may be formed of extruded aluminum alloy.

The door sweep may be formed by coextrusion of a first polymer and a second polymer, the second polymer having a lower hardness than the first polymer, the one or more downwardly depending flaps being formed of the second polymer.

### BRIEF DESCRIPTION OF THE DRAWINGS

Embodiments will now be described more fully with reference to the accompanying drawings in which:

FIG. 1 is a perspective view of an assembled door frame comprising a door sill assembly;

FIG. 2 is an elevational side view of the door sill assembly of FIG. 1, showing a portion of a door;

FIG. 3 is a perspective view of a door sill forming part of the door sill assembly of FIG. 2;

FIG. 4 is an elevational side view of the door sill of FIG. 3;

FIG. 5 is a top plan view of the door sill of FIG. 3;

FIG. 6 is a perspective view of an internal support, a sill base, setting blocks and sealing strips forming part of the door sill of FIG. 3;

FIG. 7 is an elevational side view of a door sweep forming part of the door sill assembly of FIG. 2; and

FIG. 8 is an exploded perspective view of a portion of the assembled door frame of FIG. 1.

### DETAILED DESCRIPTION OF THE EMBODIMENTS

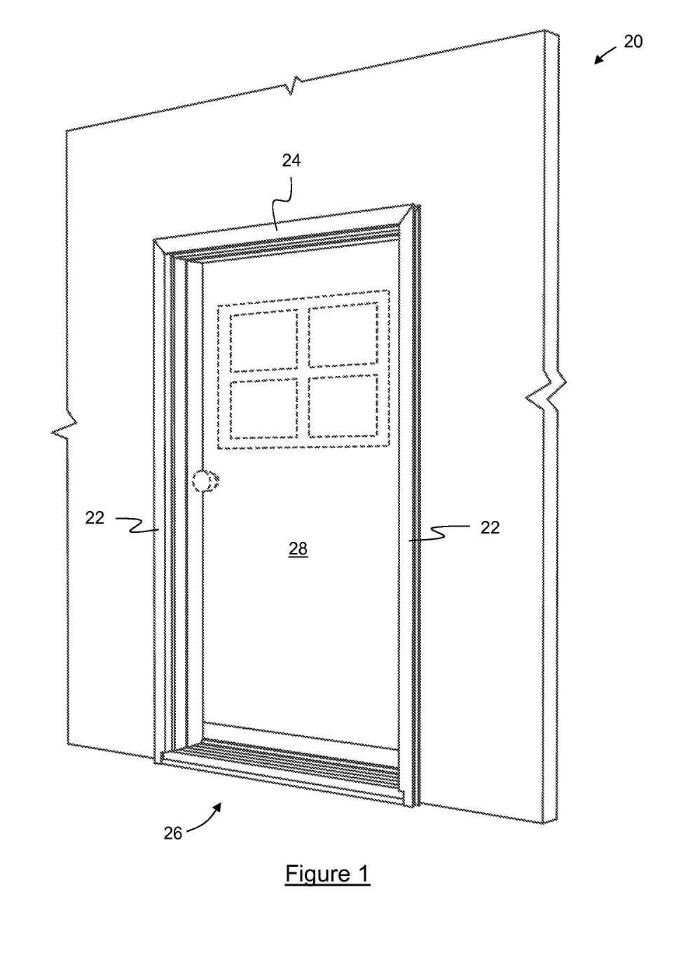

Turning now to FIG. 1, an assembled door frame of an exterior doorway of a building is shown and is generally indicated by reference numeral 20. The door frame 20 comprises two (2) door jamb portions 22, a lintel portion 24 connected to upper ends of the door jamb portions 22, and a door sill assembly 26 installed at the lower end of the door frame 20. A door 28 having an interior swing is rotatably connected to one of the door jamb portions 22 by hinges (not shown), and operably engages the door frame 20 for providing a closed position of the door, as shown in FIG. 1.

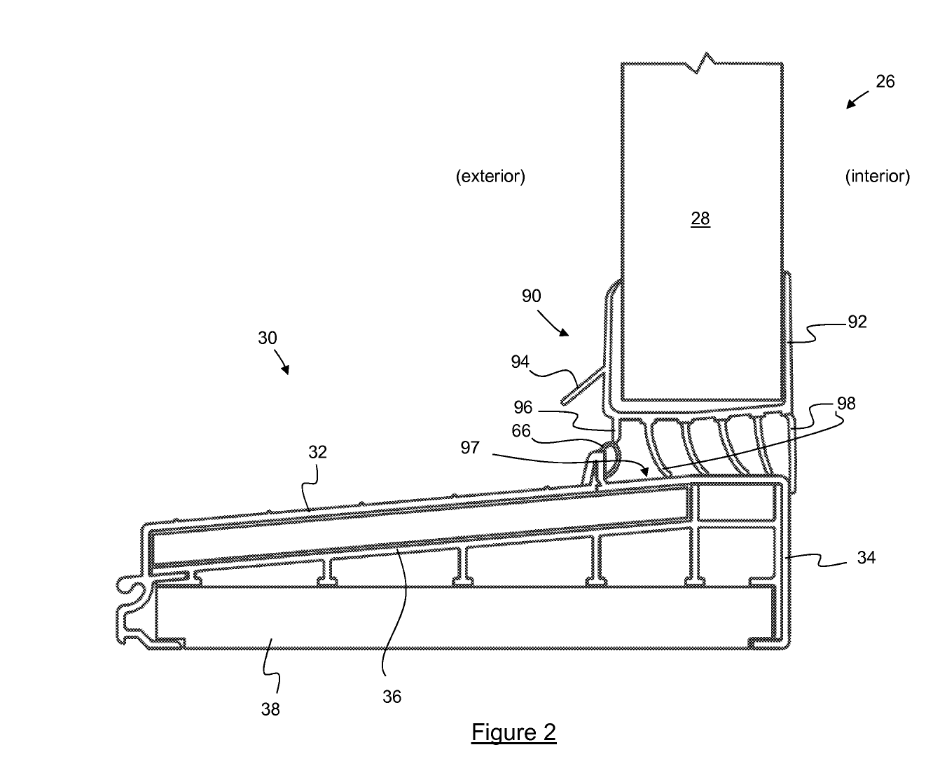

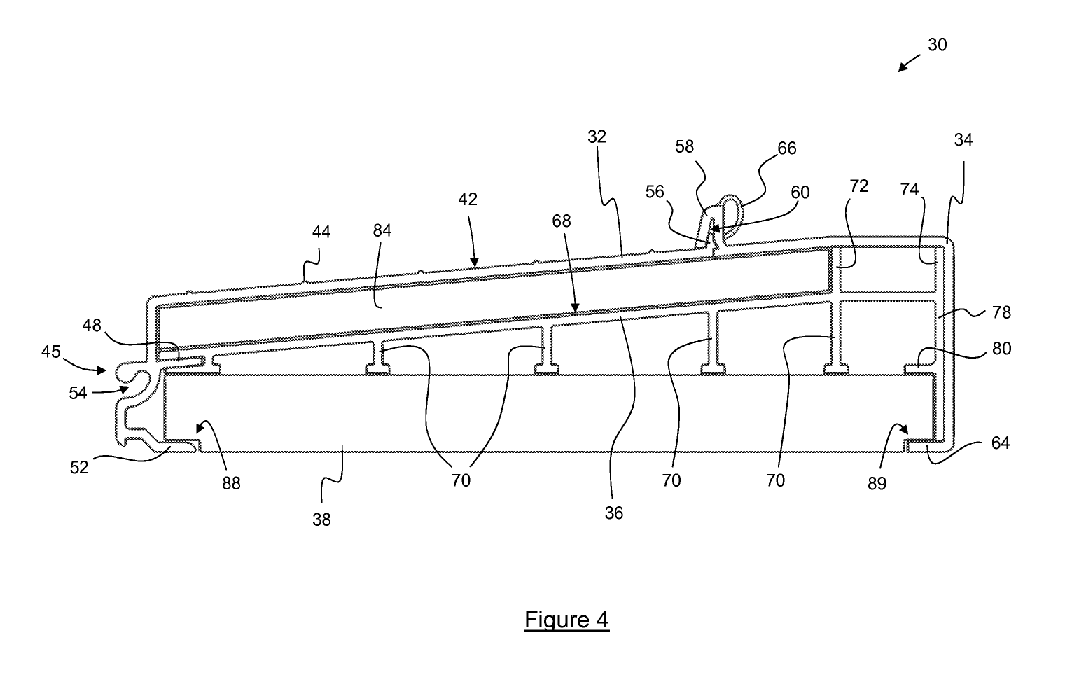

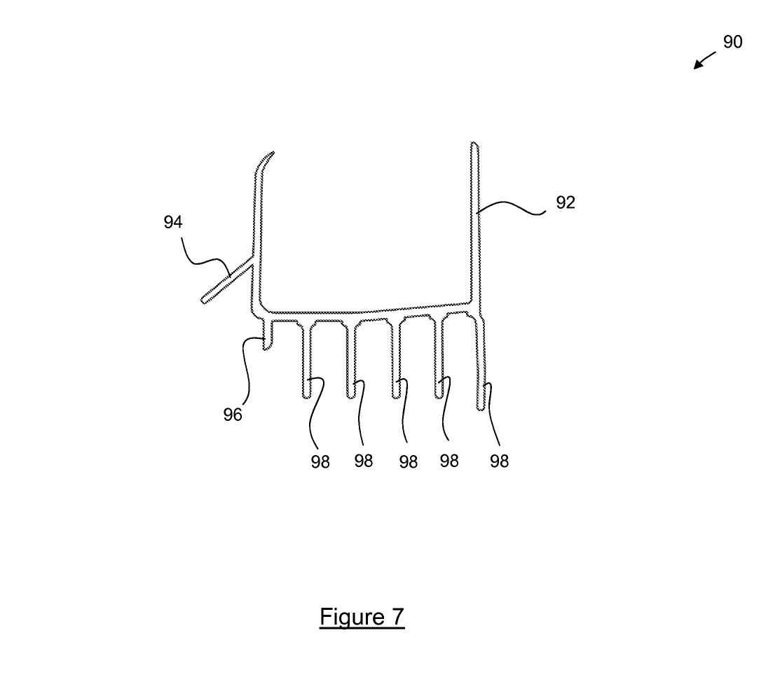

The door sill assembly 26 may be better seen in FIGS. 2 to 8. Door sill assembly 26 comprises a longitudinal door sill 30 that is configured to be connected to the lower ends of the door jamb portions 22. The door sill 30 has a generally composite construction, and comprises a sill tread 32, a sill crown 34, an internal support 36, and a sill base 38, all of which are separately-formed parts that are configured to be connected to each other during assembly of the door sill 30.

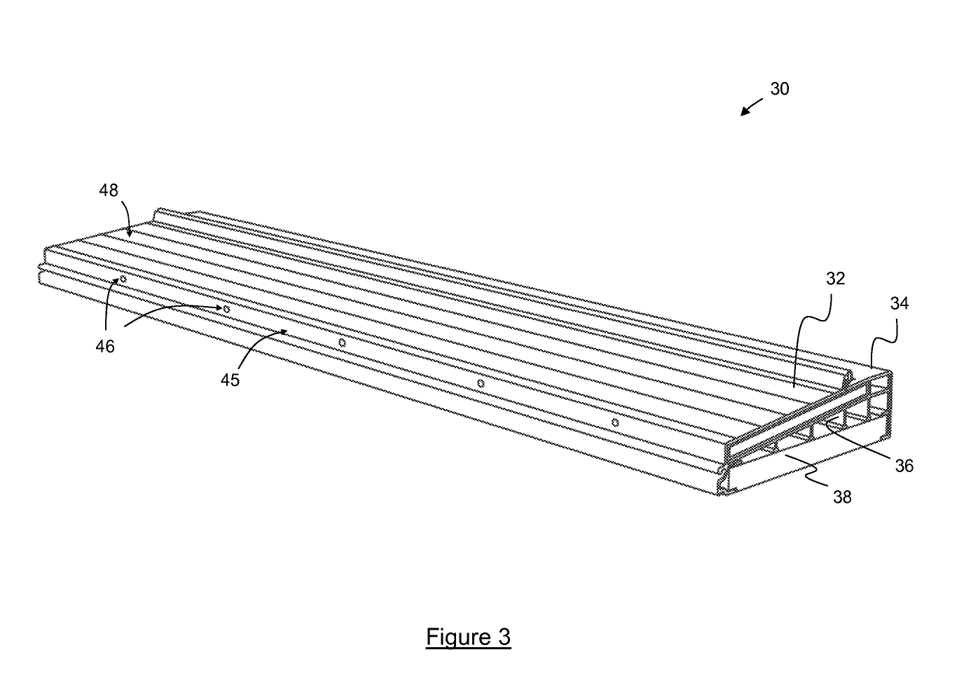

The sill tread 32 is formed by extrusion and has a generally longitudinal shape, and in this embodiment the sill tread 32 is formed of extruded aluminum alloy. The sill tread 32 has an inclined stepping surface 42, which in the embodiment shown has a plurality of longitudinal ridges 44 extending the length thereof for providing traction. The sill tread 32 comprises a front portion 45 positioned adjacent to and below the stepping surface 42 and comprising a plurality of drain apertures 46, as may be seen in FIG. 3. The sill tread 32 also comprises a pair of inner longitudinal tabs, namely a first longitudinal tab 48 and a second longitudinal tab 52, both of which extend the length of the sill tread 32 and which extend inwardly from the front portion 45. The sill tread 32 also comprises a longitudinal exterior channel 54 configured to receive a brick mold extension (not shown), and which extends the length of the sill tread 32. The sill tread 32 further comprises an upwardly protruding, longitudinal clip member 56 that extends the length of the stepping surface 42 along its edge.

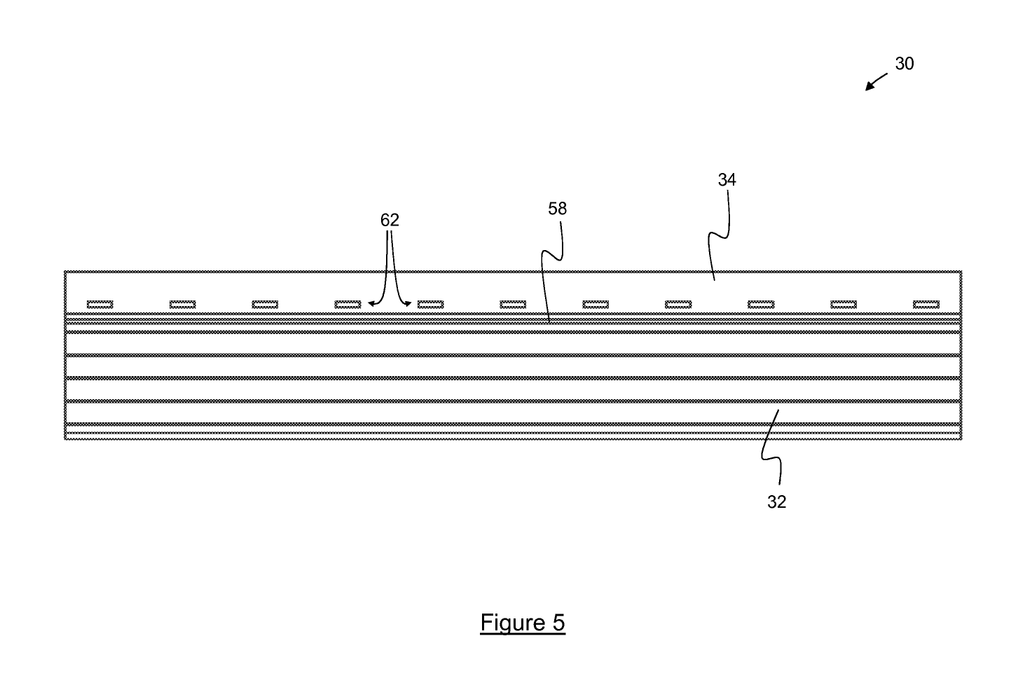

The sill crown 34 is formed by extrusion and has a generally longitudinal shape. The sill crown 34 is configured to be connected adjacent the sill tread 32, such that the sill tread 32 and the sill crown 34 together define an outer surface of the door sill 30. In this embodiment, the sill crown 34 is formed of extruded polyvinyl carbonate (PVC) having an ultraviolet (UV) light stabilizing additive combined therewith for increasing resistance of the sill crown 34 to degradation by UV light. The sill crown 34 comprises an upwardly extending longitudinal rib 58 that extends the length of the sill crown 34. The longitudinal rib 58 defines an inner longitudinal cavity 60 that is shaped to matingly receive the longitudinal clip member 56 for connecting the sill tread 32 to the sill crown 34. The sill crown 34 also comprises a plurality of drain apertures 62 positioned interiorly relative to the longitudinal rib 58. For clarity, the interior and exterior are indicated in FIG. 2. In this embodiment, the drain apertures 62 are arranged as a single row, as may be seen in FIG. 5. The sill crown 34 also comprises a longitudinal tab 64 that extends the length of the sill crown 34. The sill crown 34 further comprises a flexible, longitudinal seal 66 disposed on an interior-facing surface of the rib 58. The longitudinal seal 66 is fabricated of low-hardness PVC, and is formed by coextrusion during extrusion of the sill crown 34. As will be understood, the low-hardness PVC allows the longitudinal seal 66 to be flexible, which enables the longitudinal seal 66 to better provide a barrier to fluid, such as water (e.g. rain, melted snow, etc.) and/or air (e.g. wind). In this embodiment, the durometer of the low-hardness PVC has a value of fifty-five (55).

The internal support 36 is formed by extrusion and has a generally longitudinal shape, and in this embodiment the internal support 36 is formed of extruded recycled PVC, sometimes referred to as “regrind” PVC. The internal support 36 has a generally “webbed” configuration, and is generally configured to internally support the sill tread 32 and the sill crown 34. The internal support 36 comprises a sloped longitudinal surface 68 having a plurality of longitudinal ribs 70 depending downwardly therefrom, the longitudinal surface 68 and the longitudinal ribs 70 extending the length of the internal support 36. The internal support 36 further comprises a pair of longitudinal ribs 72 and 74 extending upwardly therefrom that are configured to abut an upper inner surface of the sill crown 34. The internal support 36 also comprises a longitudinal channel 76 that is shaped to accommodate the first longitudinal tab 48 of the sill tread 32, and a downwardly-extending longitudinal tab 78 configured to abut a lower inner surface of the sill crown 34 and having an inwardly extending longitudinal flange 80.

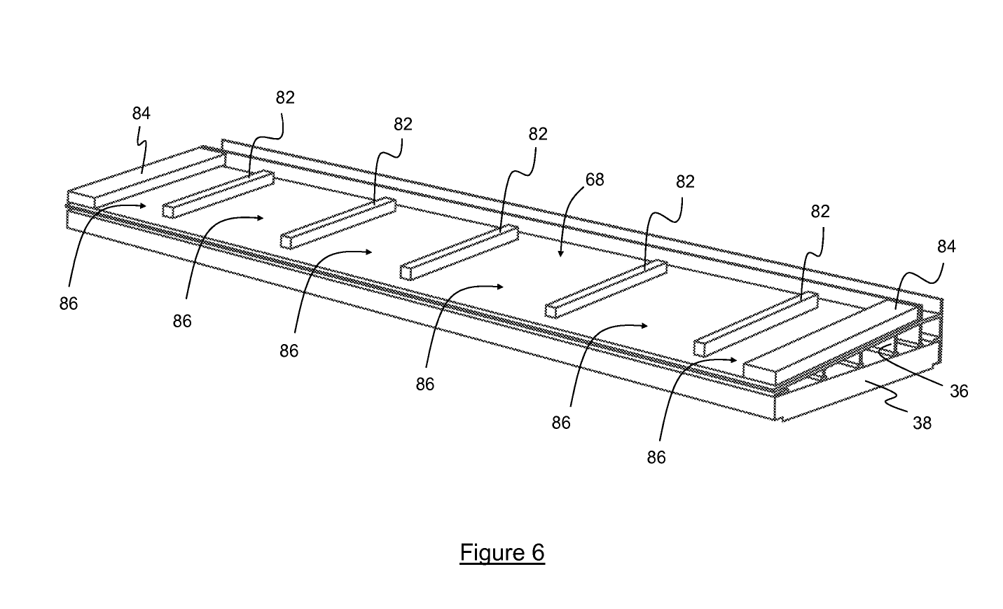

As may be seen in FIG. 6, the door sill 30 also comprises a plurality of setting blocks 82 disposed in a spaced relationship along the sloped surface 68, and intermediate the edges of the internal support 36. In this embodiment, each setting block 82 is a strip of hard rubber. The door sill 30 also comprises an adhesive sealing strips 84 disposed along each edge of the sloped surface 68 for providing a fluid seal between the internal support 36 and the sill tread 32 and the sill crown 34. In this embodiment, each sealing strip 84 is a length of glazing tape. The thicknesses of the setting blocks 82 and the sealing strips 84 are commensurate with the thickness of the gap between the sloped surface 68 and undersides of the sill tread 32 and the sill crown 34, for reducing any tendency of the sill tread 32 and the sill crown 34 to flex downwardly when pressure is applied thereto, and for thereby better supporting the sill tread 32 and the sill crown 34. The setting blocks 82 and the sealing strips 84 are arranged so as to define a plurality of drainage channels 86 therebetween.

The sill base 38 has a generally longitudinal shape and is formed by machining a slab of material, and in this embodiment the sill base 38 is formed of machined wood. The sill base 38 comprises a planar upper surface for supporting the longitudinal ribs 70 and the longitudinal flange 80 of the internal support 36. An underside of the sill base 38 comprises a first longitudinal groove 88 which is configured to receive the second longitudinal tab 52 of the sill tread 32, and a second longitudinal groove 89 which is configured to receive the longitudinal tab 64 of the sill crown 34.

The door sill assembly 26 also comprises a door sweep 90 that is configured to cooperate with the door sill 30. The door sweep 90 is formed by extrusion and has a generally longitudinal shape. In this embodiment, the door sweep 90 is formed of extruded PVC having a UV light stabilizing additive combined therewith for increasing resistance of the door sweep 90 to degradation by UV light. Door sweep 90 comprises a longitudinal channel 92 that is configured to be fitted to the bottom of the door 28. The longitudinal channel 92 has an inclined, longitudinal deflector 94 protruding downwardly from an exterior surface thereof, and extending the length thereof. The longitudinal deflector 94 is sized and positioned to extend beyond the upwardly extending rib 58 of the sill crown 34 for shielding the longitudinal seal 66 from fluid, and for directing water runoff over the longitudinal seal 66 and onto the sill tread 32, during use. The longitudinal channel 92 also has a downwardly depending, rigid longitudinal tab 96, that extends the length thereof and that is configured to abut the longitudinal seal 66 of the sill crown 34 during use. The door sweep 90 also comprises a plurality of flexible, downwardly depending longitudinal flaps 98 that are configured to contact an upper surface 97 of the sill crown 34 during use. The longitudinal flaps 98 are fabricated of low-hardness PVC and are formed by coextrusion during extrusion of the door sweep 90. As will be understood, the low-hardness PVC allows the longitudinal flaps 98 to be flexible, which enables the longitudinal flaps 98 to better provide a barrier to fluid, such as water and/or air. In this embodiment, the durometer of the low-hardness PVC has a value of fifty-five (55).

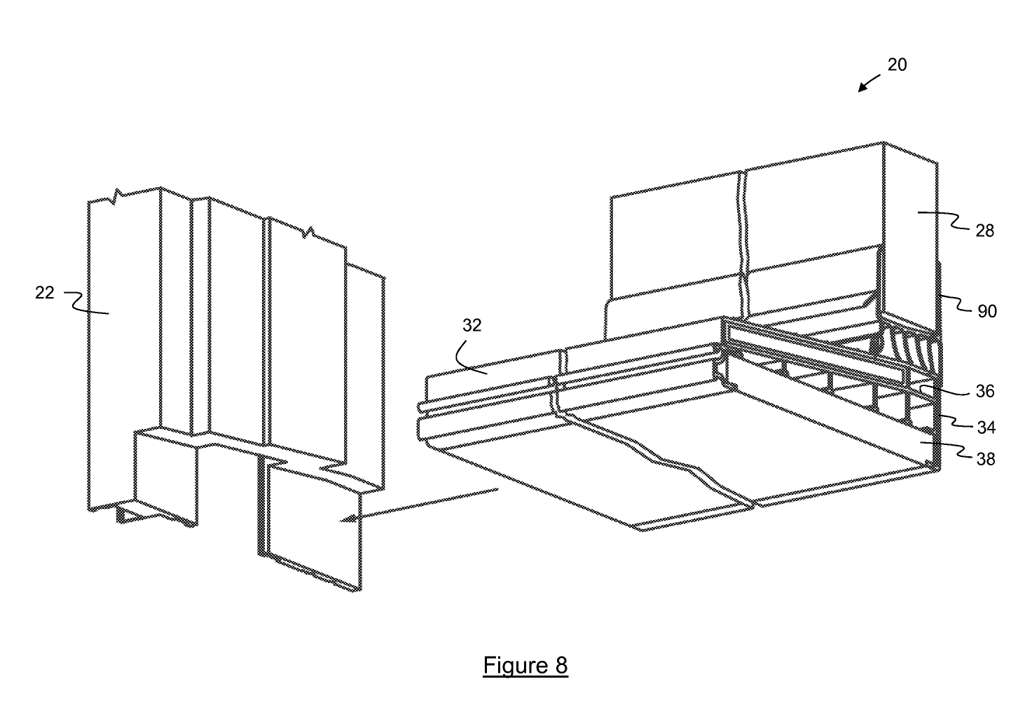

During assembly of the door frame 20, an assembled door sill 30 is connected to a lower end of the door jamb portion 22 by inserting each end of the assembled door sill 30 into a respective cutout formed at the bottom end of each door jamb portion 22, one of which may be seen in FIG. 8. The assembled door sill 30 may then be fastened to each door jamb portion 22 by inserting fasteners (not shown) through the door jamb 22 into the sill base 38, and in this embodiment the fasteners are screws. The door sweep 90 may then be fitted onto the bottom of the door 28 to complete the installation of the door sill assembly 26 in the door frame 20.

In use, the door sill assembly 26 generally limits or prevents fluid, such as water and/or air, from entering the interior of the building therethrough when the door 28 is in the closed position. As will be understood, water flowing down the exterior side of the door 28 is directed by the longitudinal deflector 94 onto the stepping surface 42 of the sill tread 32, and is thereby diverted away from the longitudinal seal 66 of the sill crown 34. The longitudinal rib 58 provides a barrier to wind, and also effectively serves as a “dam”-like barrier to water accumulating on the stepping surface 42 of the sill tread 32. The rigid longitudinal tab 96 of the door sweep 90 and the longitudinal seal 66 of the sill crown 34 cooperate to provide a barrier to any fluid directed under the longitudinal deflector 94 and over the longitudinal rib 58. The longitudinal flaps 98 direct any water that does pass between the longitudinal tab 96 and the longitudinal seal 66 downwardly into the drain apertures 62, after which it is guided via the drainage channels 86 out the drain apertures 46 to the exterior of the building.

As will be appreciated, the door sill 30 and the door sweep 90 may advantageously be manufactured using known manufacturing techniques.

As will be appreciated, manufacturing the sill support 36 of recycled PVC advantageously allows the sill support 36 to be formed of generally any grade and any colour of PVC without affecting the function or appearance of the assembled door sill 30, as a result of its internal position within the door sill 30, which advantageously reduces the cost of manufacturing of the door sill 30.

Other configurations are possible. For example, although in the embodiment described above, the sill tread comprises a front portion positioned adjacent to and below the stepping surface and which comprises a plurality of drain apertures, in other embodiments, the sill tread may alternatively not comprise drain apertures and the internal support may alternatively configured to have a front portion comprising one or more drain apertures for drainage to exterior. In one such embodiment, the sill tread may be configured to engage the front portion of the internal support for connecting the sill tread and the internal support in a manner so as to permit flow out of the one or more drain apertures. In another such embodiment, the sill tread may be configured to engage the sill base for connecting the sill tread and the sill base in a manner so as to permit flow out of the one or more drain apertures. In another alternative embodiment, both the sill tread and the internal support may each be configured to have one or more drain apertures. In one such embodiment, the drain apertures of the sill tread and the internal support may be in fluid communication with each other.

Although in the embodiment described above, the door sill comprises a sill base, in other embodiments, the door sill may alternatively not comprise a sill base. In one such embodiment, the internal support may comprise a sill base formed integrally therewith. In such an embodiment, the integrally formed sill base may be generally similar to the sill base of the embodiment described above, and may have any of a hollow configuration, a solid configuration, a generally “webbed” configuration, and a combination thereof.

Although in the embodiment described above, the sill tread, the sill crown, the internal support, and the sill base are all separately-formed parts that are configured to be connected to each other during assembly of the door sill, in other embodiments, two (2) or more of the sill tread, the sill crown, the internal support and the sill base may alternatively be formed together as a single part. For example, in one embodiment, the sill tread and the sill crown may alternatively be formed together as a first single part, and the sill base may alternatively be formed together as a second single part, with the first and second single parts each being configured to be connected to each other during assembly of the door sill.

Although in the embodiment described above, the sill crown comprises an upwardly extending longitudinal rib having a flexible, longitudinal seal disposed on an interior-facing surface thereof, in other embodiments, the sill tread may alternatively comprise the upwardly extending longitudinal rib having a flexible, longitudinal seal disposed on an interior-facing surface thereof. In one such embodiment, the sill crown may alternatively comprise a longitudinal clip member for connecting the sill crown to the sill tread.

Although in the embodiment described above, the durometer of the low-hardness PVC has a value of fifty-five (55), in other embodiments, the durometer of the low-hardness PVC may alternatively have another suitable value.

Although in the embodiment described above, the longitudinal seal is formed by coextrusion during extrusion of the sill crown, in other embodiments, the longitudinal seal may alternatively be formed separately from the sill crown and fastened to the sill crown by a suitable method for providing a fluid seal. For example, in one embodiment, the longitudinal seal may alternatively be formed separately and fastened to the sill crown using one or more fasteners, such as for example, glue, staples, rivets, and the like, or by insertion into one or more apertures, such as a groove, a slot, and the like.

Although in the embodiment described above, the longitudinal flaps are formed by coextrusion during extrusion of the door sweep, in other embodiments, the longitudinal flaps may alternatively be formed separately from the door sweep and fastened to the door sweep by a suitable method for providing a fluid seal. For example, in one embodiment, the longitudinal flaps may alternatively be formed separately and fastened to the door sweep using one or more fasteners, such as for example, glue, staples, rivets, and the like, or by insertion into one or more apertures, such as a groove, a slot, and the like.

Although in the embodiment described above, the sill tread is formed of extruded aluminum alloy, in other embodiments, the sill tread may alternatively by formed by extrusion of another suitable material, such as for example PVC or another extrudable polymer, extruded aluminum, or pulltruded fiberglass composite.

Although in the embodiment described above, the sill crown, the internal support and the door sweep are formed of extruded PVC, in other embodiments, one or more of the sill crown, the internal support and the door sweep may alternatively be formed of another suitable extrudable polymer. In still other embodiments, one or more of the sill crown, the internal support and the door sweep may alternatively be fabricated of extruded aluminum, extruded aluminum alloy, or pulltruded fiberglass composite.

Although in the embodiment described above, the sill base is formed of machined wood, in other embodiments, the sill base may alternatively be formed by machining a slab of another suitable material, such as for example, plywood, medium-density fibreboard (MDF), particle board, PVC, foamed PVC, or a PVC composite material comprising one or more of wood, flour and rice. In other embodiments, the sill base may alternatively be formed by another method, such as for example by molding a suitable material (e.g. by injection molding of a polymer), or by extrusion of a suitable material (e.g. by extrusion of an extrudable polymer, extruded aluminum, extruded aluminum alloy, or pulltruded fiberglass composite). In one example, a sill base formed by extrusion may have any of a hollow configuration, a solid configuration, a generally “webbed” configuration, and a combination thereof.

Although in the embodiment described above, each setting block is a strip of hard rubber, in other embodiments, each setting block may alternatively be a length of another material suitable for providing support.

Although in the embodiment described above, each adhesive sealing strip is a strip of hard rubber, in other embodiments, each setting block may alternatively be a length of another material suitable for providing a fluid seal.

It will be understood that the cross-sectional profiles of the sill tread, the sill crown, and the internal support are not limited to that of the embodiment described above, and in other embodiments, one or more of the sill tread, the sill crown, and the internal support may alternatively have a different cross-sectional profile. For example, the internal support may alternatively have a different configuration of longitudinal ribs than that shown.

Although in the embodiment described above, the sill crown, the sill tread, and the internal support each comprise features that extend the respective length thereof, in other embodiments, one or more of these features may alternatively not extend the respective length thereof.

Although in the embodiments described above, the sill tread comprises a plurality of drain apertures, in other embodiments, the sill tread may alternatively comprise only one drain aperture.

Although in the embodiments described above, the sill crown comprises a plurality of drain apertures, in other embodiments, the sill crown may alternatively comprise only one drain aperture.

The invention also contemplates a kit of parts which, when assembled, forms the door sill of the embodiment described above. The invention also contemplates a kit of parts which, when assembled, forms the door sill assembly of the embodiment described above.

Although embodiments have been described above with reference to the accompanying drawings, those of skill in the art will appreciate that variations and modifications may be made without departing from the scope thereof as defined by the appended claims.

What is claimed is:

1. A door sill assembly, comprising:
a door sill comprising:
a sill crown having one or more upper drain apertures therein,
a sill tread defining a stepping surface, and
an internal support at least partially supporting the sill crown and the sill tread and having a drainage surface, at least a portion of the drainage surface being sloped, at least one of the sill tread and the internal support having one or more lower drain apertures therein, the drainage surface defining at least one internal drainage channel in fluid communication with at least one upper drain aperture and at least one lower drain aperture,
at least one of the sill crown, the sill tread, and the internal support being separately formed.

2. The door sill assembly of claim 1, wherein the door sill further comprises an upwardly extending longitudinal rib, the upper drain apertures being interiorly adjacent the longitudinal rib.

3. The door sill assembly of claim 2, wherein the door sill further comprises a longitudinal seal disposed along the longitudinal rib.

4. The door sill assembly of claim 3, further comprising:
a door sweep configured to be fitted to the bottom of a door.

5. The door sill assembly of claim 4, wherein the door sweep comprises a downwardly depending longitudinal tab configured to cooperate with the longitudinal seal for providing a fluid barrier.

6. The door sill assembly of claim 4, wherein the door sweep further comprises an inclined longitudinal deflector sized to extend beyond the upwardly extending rib when the door is in a closed position.

7. The door sill assembly of claim 4, wherein the door sweep further comprises one or more downwardly depending flaps for engaging the sill crown.

8. The door sill assembly of claim 1, wherein the sill crown and the sill tread are separately formed and connected to each other.

9. The door sill assembly of claim 1, wherein the door sill further comprises a plurality of setting blocks disposed on the drainage surface for supporting at least the sill tread.

10. The door sill assembly of claim 1, wherein the door sill further comprises a transverse seal at each longitudinal end of the drainage surface for providing a fluid barrier.

11. The door sill assembly of claim 1, wherein the door sill further comprises a sill base at least partially supporting the internal support.

12. The door sill assembly of claim 11, wherein the sill base is formed integrally with the internal support.

13. The door sill assembly of claim 11, wherein the sill base is separately formed.

14. The door sill assembly of claim 11, wherein the sill base comprises a machined board.

15. A door sill comprising:
a sill crown having one or more upper drain apertures therein;
a sill tread defining a stepping surface; and
an internal support at least partially supporting the sill crown and the sill tread and having a drainage surface, at least a portion of the drainage surface being sloped, at least one of the sill tread and the internal support having one or more lower drain apertures therein, the drainage surface defining at least one internal drainage channel in fluid communication with at least one upper drain aperture and at least one lower drain aperture,
at least one of the sill tread, the sill crown and the internal support being separately formed.

16. A kit for assembling the door sill of claim 15.

17. A door sill assembly, comprising:
a door sill comprising:
an upwardly extending longitudinal rib, and
a longitudinal seal disposed along an interior-facing surface of the longitudinal rib; and
a door sweep configured to be fitted to a bottom of an interior-swinging door, the door sweep comprising a downwardly depending longitudinal tab configured to abut the longitudinal seal for providing a fluid barrier.

18. The door sill assembly of claim 17, wherein the door sweep further comprises one or more downwardly depending flaps for engaging the door sill.

19. The door sill assembly of claim 17, wherein the door sweep further comprises an inclined longitudinal deflector sized to extend beyond the upwardly extending rib when the door is in a closed position.

20. The door sill assembly of claim 17, wherein the door sill further comprises:
a sill tread defining a stepping surface, and
a sill crown,
one of the sill tread and the sill crown comprising the longitudinal rib and the longitudinal seal.
